(19) United States
(12) Patent Application Publication
(10) Pub. No.: US 2020/0270399 A1
(43) Pub. Date: Aug. 27, 2020

(54) POLYMERIZATION OF PRIMARY PHOSPHINES WITH OLEFINS TO GENERATE PHOSPHORUS BASED POLYMER NETWORKS

(71) Applicant: THE UNIVERSITY OF WESTERN ONTARIO, LONDON, ON (CA)

(72) Inventors: TYLER J. CUTHBERT, VICTORIA, BC (CA); RYAN GUTERMAN, THORNHILL, ON (CA); ELIZABETH RACHEL GILLIES, LONDON, ON (CA); JOHANNA BLACQUIERE, LONDON, ON (CA); JOE GILROY, LONDON,ON (CA); PAUL JOSEPH RAGOGNA, STRATFORD, ON (CA)

(21) Appl. No.: 16/647,059

(22) PCT Filed: Sep. 13, 2018
(86) PCT No.: PCT/CA2018/051136

§ 371 Date: Mar. 13, 2020

Related U.S. Application Data
(60) Provisional application No. 62/558,093, filed on Sep. 13, 2017.

(51) Int. Cl. C08G 79/06; C08K 5/315

(52) U.S. Cl. CPC C08G 79/06; C08K 5/315

(57) ABSTRACT

The present disclosure relates to the synthesis of phosphorus based polymer networks by thermal or photopolymerizaton of primary phosphines with olefins which exhibit tunable oxidative and mechanical properties. The method involves mixing a polymerizaton initiator with a phosphine and an olefin to produce a mixture and exposing the mixture to any one or combination of light, electron beam, or heat to induce polymerizaton of the primary phosphines with the olefins wherein the reactivity of the primary phosphines results in the production of polymers containing P—C bonds. When the olefin is a flexible alkene, upon polymerizaton a polymer network is produced which is less rigid than a polymer network produced using a rigid alkene. If a rigid alkene is used, upon polymerizaton a polymer network is produced that is firmer than a polymer network produced using a flexible alkene. In this way the physical properties of the polymers containing P—C bonds is tunable.

### FIELD

The present disclosure relates to the synthesis of phosphorus based polymer networks by the polymerizaton of primary phosphines with olefins, and more particularly the present disclosure provides synthesis routes for producing phosphorus based polymer networks with tunable oxidative and mechanical properties.

### BACKGROUND

New developments in polymer science can often be traced to research in fundamental synthetic chemistry. The transition of a technology from small molecule to polymer science provides engineers and materials scientists a tool for new discoveries and applications. The present inventors' focus is to explore the chemistry of phosphorus and its use towards polymer design. There is currently a large number of phosphorus containing polymers in the literature with a wide variety of applications. The most common include polyphosphazenes, phosphonium polyelectrolytes, and polyphosphonates. Despite exhibiting excellent thermal stability, polymers containing P—N or P—O—C bonds suffer greatly from hydrolysis. The reason for their utilization stems from their ease of preparation as opposed to P—C bonds, which are resistant to hydrolysis but traditionally more difficult to prepare.

### SUMMARY

The present disclosure provides a method for producing phosphorus based polymer networks with tunable oxidative and mechanical properties, comprising mixing a polymerization initiator with a primary phosphine and an olefin to produce a mixture and exposing the mixture to an agent selected to activate the polymerization initiator to induce polymerization of the primary phosphines with the olefins wherein the reactivity of the primary phosphines results in the production of polymers containing P—C bonds.

Thus the present disclosure provides synthesis routes for producing phosphorous based polymer networks with tunable oxidative and mechanical properties depending on the type of alkene that is used.

The present disclosure provides a method for producing a phosphorus based polymer network, comprising:

mixing a polymerization initiator with a primary phosphine and an olefin to produce a mixture and exposing the mixture to an agent selected to activate the polymerization initiator to induce polymerization of the primary phosphine with the olefin wherein the reactivity of the primary phosphine results in the production of polymers containing P—C bonds.

The polymerization initiator may be a photoinitiator, a thermal initiator or an e-beam initiator.

The agent selected to activate the polymerization initiator may be any one or combination of electron beam, heat and light.

The polymerization initiator may be any one of bisacyl phosphineoxide derivatives (BAPO), VAZO type initiators, phenylacetylphenone derivatives, substituted phenylacetylphenone derivatives, acylgermanes and acylstannanes.

The VAZO type initiators may be substituted azonitrile compounds.

The primary phosphine may be a compound having the general formula of R—PH₂ wherein R may be any one of an optionally substituted alkyl group, optionally substituted heteroalkyl group, optionally substituted cyclic alkyl groups, optionally substituted heterocyclic alkyl group, optionally substituted aryl groups, optionally substituted heteroaryl groups, or optionally substituted aralkyl group. The alkyl group may comprise 2 to 25 carbon atoms.

The cyclic alkyl may be any one of cyclohexyl or substituted cyclohexyl, adamantly or substituted adamantly and pineneyl or substituted binenyl group, and the aryl group is any one of Naphthyl or substituted naphtyl, terphenyl or substituted terphenyl, binaphthyl or substituted binaphthyl.

The olefin may be a multifunctional alkene having two or more carbon-carbon double bonds (C═C) linked by an aliphatic chain, and the one or more carbon atoms in the aliphatic chain may be optionally substituted by one or more heteroatoms.

The olefin may be a multifunctional alkene having two or more unsaturated aliphatic chains linked by a cyclic group. The cyclic group may be a heterocyclic aliphatic group or an aromatic group.

The cyclic group and carbon-carbon double bonds (C═C) in the unsaturated aliphatic chains may be apart from each other by not more than three atoms.

Each end of the olefin may be terminated by a carbon-carbon double bond (C═C).

The method may further comprise adding an inhibitor of phosphine oxidation.

In an embodiment of the present disclosure, the molar ratios of primary phosphine:alkene may range from about 0.05:0.95 to about 0.95:0.05.

The polymerization initiator may be added in the amount of about 0.01 to about 10 mol % of either primary phosphine or olefin.

The present disclosure provides a phosphorus based polymer network produced by the method described above. This polymer network is characterized by tunable oxidative and mechanical properties.

This polymer network may be used as a flame retardant.

This polymer network may be used as an antibacterial agent.

This polymer network may be used as a metal scavenger.

A further understanding of the functional and advantageous aspects of the present disclosure can be realized by reference to the following detailed description and drawings.

### BRIEF DESCRIPTION OF THE DRAWINGS

Embodiments will now be described, by way of example only, with reference to the drawings, in which:

FIG. 1 shows examples of primary phosphines.

FIG. 2 shows a comparison between the “thiol-ene” reaction (FIG. 2A) and “phosphane-ene” reaction (FIG. 2B).

FIG. 3 shows exemplary compounds that can be used to synthesize “phosphane-ene” polymer networks with tunable physical properties according to the present disclosure, where FIG. 3A shows one example of phosphine, FIG. 3B shows one example of a flexible alkene, FIG. 3C shows one example of a rigid alkene, and FIG. 3D shows one example of an initiator.

FIG. 4 shows the IR spectra of cured “phosphane-ene” polymer networks for formulation 1 (FIG. 4A), formulation 2 (FIG. 4B), and formulation 3 (FIG. 4C).

FIG. 5 shows the solid-state ³¹P{¹H} NMR spectrum of formulation 2 prior to leaching in toluene.

FIG. 6 shows the ³¹P{¹H} NMR spectrum of formulation 2 after leaching in toluene for 24 hours.

FIG. 7 shows ³¹P{¹H} NMR spectrum of formulation 2 after leaching in toluene for 24 hours and oxidation in air.

FIG. 8 shows the thermal gravimetric analysis (TGA) plot of formulations 1, 2 and 3 in dry air.

FIG. 9 shows TGA plot of formulation 4, 5 and 6 in dry air.

FIG. 10 is an optical photograph of formulation #5 polymer after exposure to a flame for about 6 seconds.

FIG. 11 shows a comparison of bacterial culture without (left) and with (right) exposure to phosphonium polyelectrolyte. Each dot represents a bacterial colony.

FIG. 12 is an optical photograph of Grubbs catalyst 1st generation in toluene. Initially the solution is dark red (left) but after 2 hours (right) the solution became noticeably clearer due to the metal scavenging polymer.

FIG. 13 is an optical photograph showing polymer bound to Pd(PPh₃)₄ settling out of solution.

### DETAILED DESCRIPTION

Various embodiments and aspects of the disclosure will be described with reference to details discussed below. The following description and drawings are illustrative of the disclosure and are not to be construed as limiting the disclosure. The Figures are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. In one non-limiting example, the terms “about” and “approximately” mean plus or minus 10 percent or less.

As used herein, the term “olefin” or “alkene” refers to an unsaturated hydrocarbon that contains at least one (preferably at least two) carbon—carbon double bond. In the context of the present disclosure, the term “olefin” or “alkene” is interpreted as also encompassing hetero alkene and substituted alkene.

As used herein, the term “flexible alkene” refers to a multifunctional olefin having two or more carbon-carbon double bonds (C═C) linked by an aliphatic chain. In an embodiment of the disclosure, one or more carbon atom in the aliphatic chain may optionally be substituted with one or more heteroatom.

As used herein, the term “rigid alkene” refers to a multifunctional olefin, having two or more unsaturated aliphatic chains linked by a cyclic group.

As used herein, the term “primary phosphine” refers to a compound having the general formula of R—PH₂ wherein R is any one of optionally substituted alkyl group, optionally substituted heteroalkyl group, optionally substituted cyclic alkyl groups, optionally substituted heterocyclic alkyl group, optionally substituted aryl groups, optionally substituted heteroaryl groups, or optionally substituted aralkyl group.

As used herein, the term “polymerization initiator” refers to an agent that can produce radicals under specific conditions such as light or electron beam irradiation or by heating. Examples of radical initiators include bisacyl phosphineoxide derivatives (BAPO), VAZO type initiators, such as substituted azonitrile compounds, phenylacetylphenone derivatives, substituted phenylacetylphenone derivatives, acylgermanes and acylstannines.

Unless defined otherwise, all technical and scientific terms used herein are intended to have the same meaning as commonly understood to one of ordinary skill in the art.

The present disclosure for producing phosphorus based polymer networks by the polymerization of primary phosphines with olefins exploits the reactivity of primary phosphines to generate polymers containing P—C bonds in an efficient manner. The polymerization may be carried out in the presence of one of, of a combination of a photoinitiator, thermal initiator and e-beam initiator. A key development for this approach stems from the combination of two fields of chemistry. The first using radical mediated P—C bond forming reactions, and the second using primary phosphines. The ability to form P—C bonds from a primary phosphine and an olefin is well-understood chemistry developed in the 1950s. Currently this chemistry is applied on the industrial scale for the synthesis of nearly all alkyl phosphines commercially available. This process however was not suitable for polymer science.

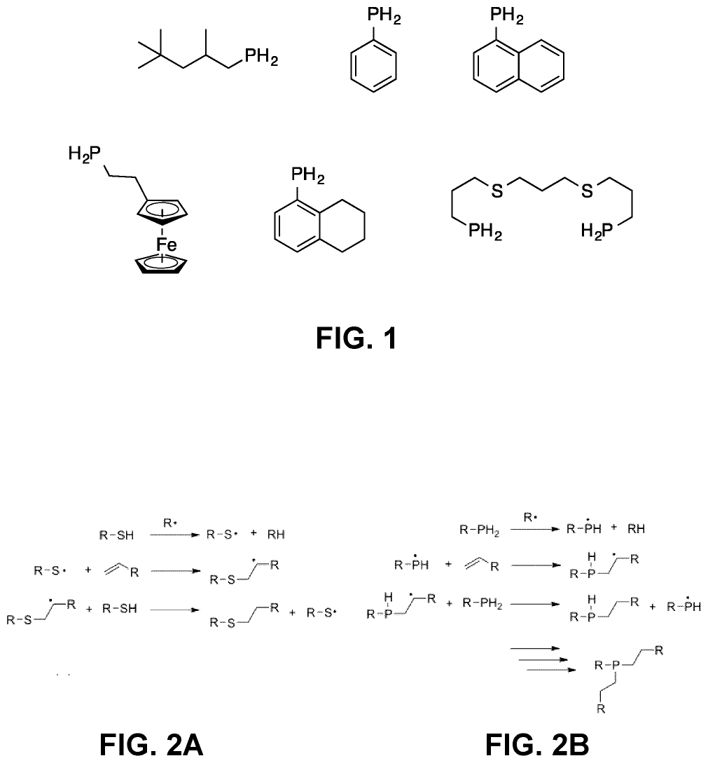

This development in fundamental phosphorus chemistry provided the necessary perspectives to synthesize phosphine monomers in a safe and applicable manner (FIG. 1). The polymerization processes between phosphines and alkenes follow a step-growth mechanism similar to that of thiols and alkenes, see FIG. 2A and 2B which shows a comparison between the “thiol-ene” reaction (FIG. 2A) and “phosphane-ene” reaction (FIG. 2B).

An initiator (thermal or photochemical) generates radicals that react with primary phosphines. The phosphinoyl radical then forms a P—C bond with a nearby alkene. The carbon centered radical then abstracts a hydrogen from a phosphine regenerating the phosphinoyl thus continuing the polymerization. This polymerization process possess' the fast kinetics of radical chemistry while increasing in molecular weight according to a step growth process. The mechanism however is not unique to phosphorus and can be accomplished using thiols and alkenes (referred to as the “thiol-ene” click reaction) (FIG. 2A).

The similarities between thiols and phosphines had not gone unnoticed during the early development of this chemistry. Despite such observations, only thiols have been greatly exploited in materials and polymer science. Phosphines provide a complimentary polymer system to sulfur in generating new materials. This is highlighted in the fact that phosphorus-containing polymers have unique applications that cannot be substituted with sulfur. It is here that the present inventors demonstrate a general approach to generate a new class of phosphorus-containing polymers with the potential to be exploited in a variety of industries. The present disclosure provides synthesis methods for producing such phosphorus-containing polymers which allows for tunable features such as tunable oxidative and mechanical properties, displays flame retardant behaviour, possesses metal scavenging.

### EXPERIMENTAL

### Photopolymerization

Approximately 70 mg of polymer formulation containing 0.5 wt BAPO photoinitiator, phosphine and an alkene was added to a 1 mm deep Teflon mold in a nitrogen filled glovebox. The mold was then placed in a sealed vessel with a glass window. The assembly was then irradiated with UV light (149 mJ/cm², 120 mW/cm²) three times to form a solid polymer disk. The disk was removed from the mold and immediately brought in to a nitrogen-filled glovebox for storage.

### Characterization of Polymer Discs

Characterization by FTIR-ATR spectroscopy confirmed the conversion of both allyl and phosphine functionality post polymerization. The reduced intensity of the P—H vibration at ˜2300 cm⁻¹ and =C—H vibration at ˜3100 cm⁻¹ indicated conversion post irradiation. Depending on the stoichiometry between phosphine and olefin, each polymer network may contain excess olefin or phosphine at complete conversion.

### Mass Swelling Ratio and Gel Content

Samples (˜70 mg) were immersed in 15 mL of toluene and left for at least 24 hours. Swelling ratios were calculated by using the equation qw=Ws/Wd, where Ws is the swollen mass and Wd is the dry mass. Samples were then heated in vacuo to remove residual solvent. Gel content was calculated by using the equation % Crosslinked material=We/Wd×100 where We is the polymer mass after leaching in toluene and drying, and Wd is the original mass of the polymer.

### Determination of the Anti-Microbial Efficacy

This procedure was adapted from ASTM E2149-13A “Determining the Antimicrobial Activity of Antimicrobial Agents Under Dynamic Contact Conditions”. Buffer Solution (0.25M KH₂PO₄ stock buffer, 0.3 mM KH₂PO₄ working buffer) KH₂PO₄ (34 g, 0.25 mol) was combined with deionized water (500 mL) in a 1000 mL Erlenmeyer flask. pH was adjusted to 7.3 using NaOH (1 M) and then diluted to 1000 mL with deionized water, and stored at 4° C. Working buffer was then prepared fresh from this solution. 0.25M KH₂PO₄ (1 mL) was combined with deionized water (800 mL) capped with tin foil and sterilized (autoclave 120° C./20 min).

### Bacteria

Escherichia coli (*will get the e.coli wildtype to put here) (2-3 looped cultures) were transferred to an Erlenmeyer flask (25 mL) with sterile broth (10 mL). This suspension was shaken at 175 rpm at 37° C. for 18 hours. The bacteria suspension was then pelletized by centrifugation for 10 min, suspended in 0.3 mM KH₂PO₄ (10 mL) by vortex, pelletized by centrifugation for 10 min, resuspended in 0.3 mM KH₂PO₄ and diluted to 0.2 0.3 OD @600 nm (approximately 108 CFU/mL). This suspension was then diluted to 106 CFU/mL with 0.3 mM KH₂PO₄ buffer solution.

Surface Preparation

Surfaces were pre washed with deionized water to remove any possible leaching molecules, sterilized with a 70% EtOH solution and let to air dry, then washed with 0.3 mM KH₂PO₄ buffer prior to use.

### Antimicrobial Procedure

Bacteria (0.1 mL, 105 CFUs) were transferred to a sterilized Erlenmeyer flask (25 mL) with 5 mL of KH₂PO₄ buffer solution. The flasks were capped with aluminum foil and put onto a wrist action shaker (60 rpm) for 24 hours. Solutions were then transferred to a centrifuge tube and vortexed for 30 seconds. Serial dilutions using 0.3 mM KH₂PO₄ to the expected 102 CFUs and 103 CFUs on EMB Levin Agar was completed by scratch plating. Agar plates were incubated for 24 h at 37° C., then CFUs were counted and compared to inoculum only control.

### RESULTS AND DISCUSSION

### Polymer Characterization and Oxygen Scavenging for Flame Retardancy Applications

Phosphorus containing polymers have seen much use as flame-retardants since their discovery. The mechanism for this behaviour is highly dependent on the composition of the polymer and molecular structure of the phosphorus compound. Generally, phosphorus promotes charring behavior in the material preventing ignition. Quite often phosphorus is used as an additive in a polymer matrix to promote such processes, however this may lead to reduced mechanical strength and incompatibility at the necessary phosphorus loadings. The solution to this problem is to synthesize polymers with phosphorus in the backbone of the polymer itself. This approach has shown to improve thermal stability relative to the additive approach. The inventors also consider the oxidation state of the phosphorus in question within the polymer itself. The vast majority of flame retardant polymers possess high oxidation state phosphorus atoms as they are typically air stable. The present approach disclosed herein however is to take advantage of lower oxidation state phosphines in a polymer system. The inventors postulated that these phosphines at elevated temperatures would exhibit an increased rate of oxidation thus quenching its environment of molecular oxygen.

The inventors' present approach uses monomers to generate polymer networks through thermal or photochemical means allowing for spatial and temporal control over the polymerization process.

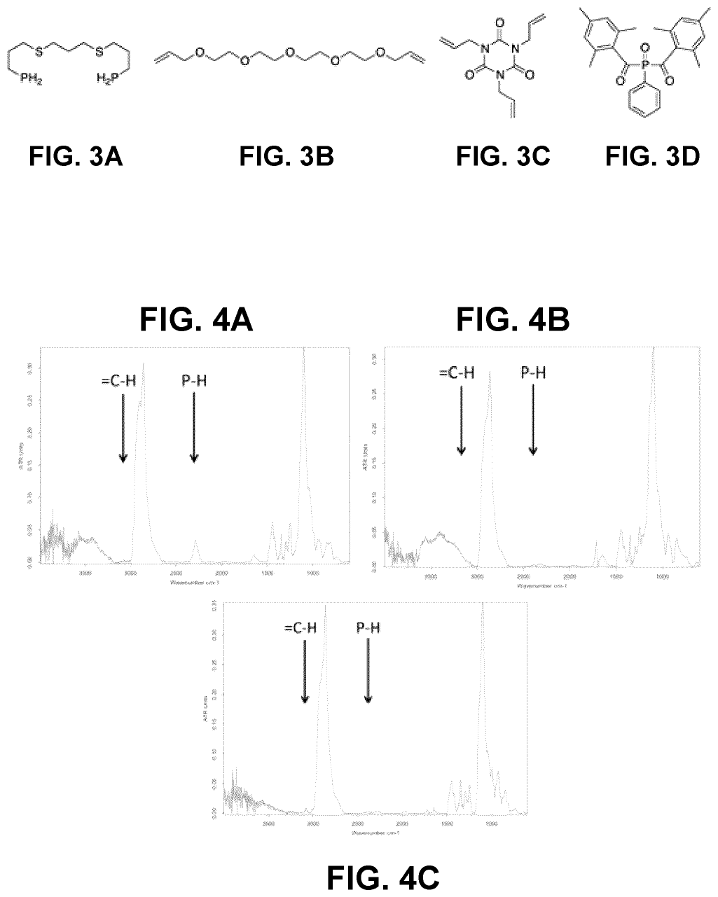

In non-limiting exemplary embodiments of the present disclosure, six polymer formulations were prepared and analyzed for their oxidative properties when exposed to air. Each formulation included initiator, phosphine, a flexible alkene to generate soft networks, or a rigid alkene to generate firmer networks. As shown in FIG. 3, a non-limiting example of a formulation contains 0.5 wt of bis(tirmethylbenzoyl) phenylphosphine oxide (BAPO) as a photoinitiator (FIG. 3D), a 1,11-(diphosphino)-4,8-dithio-hendecane as a phosphine (FIG. 3A), tetraethyleneglycoldiallylether as a flexible alkene (FIG. 3B) and 1,3,5-triallyl-1,3,5-triazine-2,4,6(1H,3H,5H)- trione as a rigid alkene (FIG. 3C). The phosphine [FIG. 3A] was synthesized according to a literature procedure.

The phosphine-alkene stoichiometry was adjusted to determine the effect of excess phosphine or excess alkene in the network upon exposure to air. At a phosphine:alkene molar ratio of 0.75:1, excess phosphine moieties would be exposed from the polymer network at complete alkene conversion. At a ratio of 0.5:1, all phosphines and alkenes may be consumed. At a ratio of 0.38:1, excess alkene moieties would be exposed from the polymer network at complete phosphine conversion. The swelling nature and gel content were determined to probe network properties and to remove any leachable material prior to oxidation (Table 1).

TABLE 1
Swelling ratio and gel content of all polymer networks used in this study.

| | | | | |
|---|---|---|---|---|
| Soft Networks | 1 | 0.75:1 | 1.92 ± 0.01 | 89 ± 1.2% |
| [B] | 2 | 0.5:1 | 1.62 ± 0.01 | >98% |
| | 3 | 0.38:1 | 2.52 ± 0.26 | 81 ± 1.7% |
| Firm Networks | 4 | 0.75:1 | 1.29 ± 0.01 | >98% |
| [C] | 5 | 0.5:1 | 1.05 ± 0.01 | >98% |
| | 6 | 0.38:1 | 1.05 ± 0.01 | >98% |

Formulations 1 to 3 are composed of flexible components (see FIG. 3A and FIG. 3B) and thus possess higher swelling ratios. The swellability of these polymers depends on crosslink density of the network which can be tuned by varying the molar ratio of the phosphine and alkene components. Both formulation 1 and 3 contain excess PH2 and alkene functionality respectively while formulation 2 possesses an equivalent stoichiometry, as shown in the IR spectra of the cured samples (FIG. 4A, 4B and 4C for formulations 1, 2, and 3 respectively).

In the case for formulation 1 (FIG. 4A), at full conversion of alkene functionality there is still leftover phosphine. This stoichiometry promotes lower crosslink densities and some unreacted materials, which can be removed by swelling the polymer in toluene. Gel content for this system is approximately 89%, consistent with similar thiol-ene systems. Formulation 3 contains excess alkene and thus displays a similar trend although with greater swellability and lower gel content. When the molar ratios are adjusted to 0.5[PH₂]:1 [Alkene], both functional group are consumed (FIG. 4B) creating a polymer with higher crosslink density, lower swellability, and over 98% gel content. ³¹P{¹H} solid-state NMR spectroscopy reveals the chemical environment surrounding the phosphorus atom within the network. The ability to directly probe the chemical environment of this material in such a manner provides an unparalleled analytical handle not shared with thiol-ene systems. Formulation 2 was chosen for solid-state NMR spectroscopic analysis

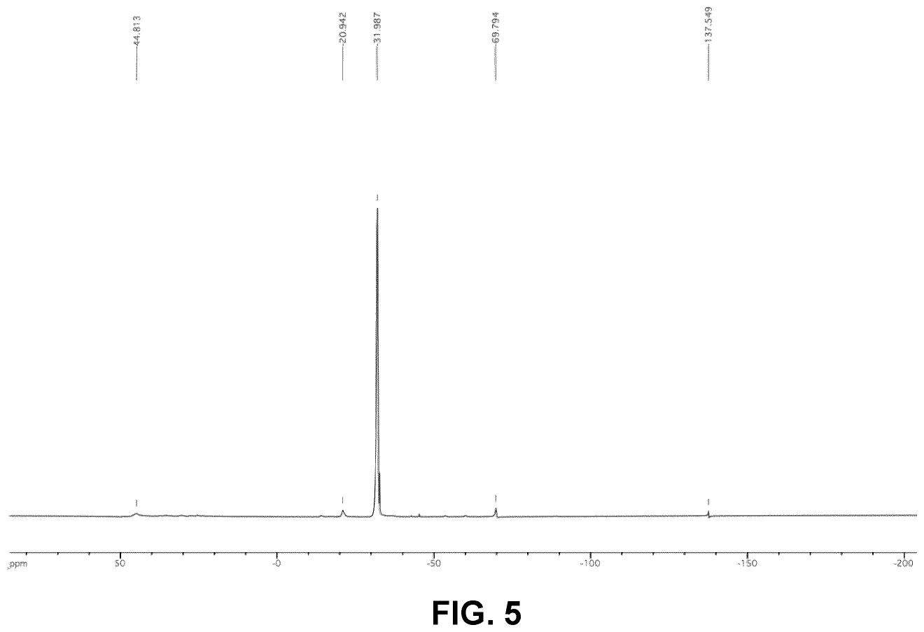

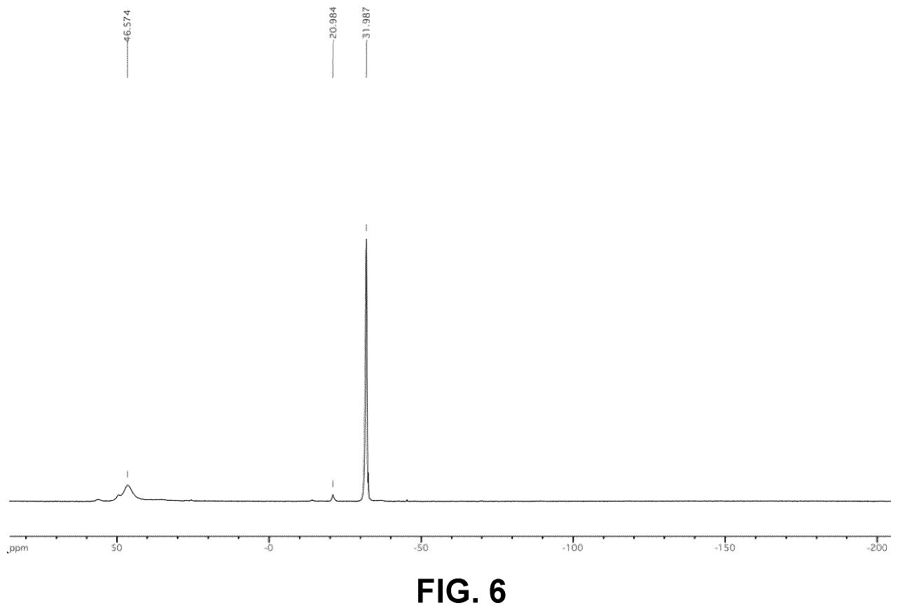

(FIG. 5). Small amounts of primary (δ=−137.5 ppm) and secondary phosphines remain (δ=−69.8 ppm) while most have been converted to the tertiary phosphine (δ=−31.98 ppm). The inventors believed that there may be a slight amount of unreacted material within this polymer. A leached samples was analyzed using solid-state NMR spectroscopy to determine whether this was the case (FIG. 6).

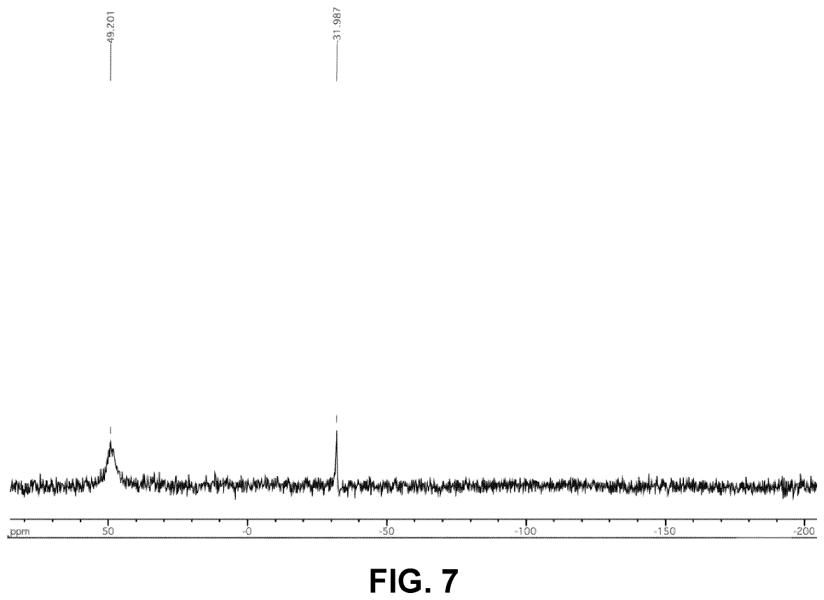

This process removed all traceable primary phosphines and significantly cleared the baseline of phosphorus peaks. However a signal at ˜−20 ppm remained and another signal at ˜46 ppm grew in intensity. The inventors believe that the first signal is a result of the anti-Markovnikov addition of the secondary phosphine to the alkene. The broad peak at −46 ppm was believed to come from phosphine oxide, which may have formed during handling in air. The leached sample was then oxidized in dry air at 100° C. to corroborate this assertion. The signal at 46 ppm increased in intensity relative to the tertiary phosphine signal at −32 ppm, confirming the inventors' finding (FIG. 7).

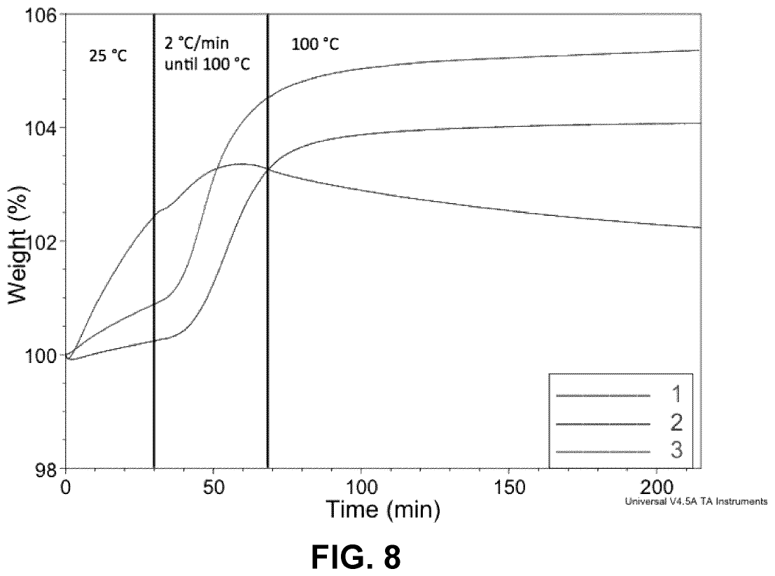

The present inventors further explored the oxygen scavenging properties of these materials. Samples were milled by hand, placed in a ceramic cup and heated within a TGA instrument under an atmosphere of dry air (100 mL/min). Oxidation of the polymer was measured as an increase in mass. Formulations 1 to 3 were analyzed according to the following procedure. First, the samples were kept at 25° C. for 30 minutes, then heated at 2° C./min until 100° C. and kept at this temperature for 215 minutes (FIG. 8).

It was observed that depending on the molar ratios of the functional groups, different oxidation behavior was observed. As well, there was a direct correlation between phosphorus content and % mass increase in the sample. All samples oxidized in air at 25° C., with formulation 3 oxidizing the quickest. Heating the samples increased the rate of oxidation until a maximum was obtained. Assuming a 1:1 phosphorus-oxygen ratio, formulation 1 should increase by ˜5 wt when fully oxidized, while formulations 2 and 3 should increase by ˜4 and ˜3 wt respectively. The thermographs show excellent agreement with theoretically calculated values. Surprisingly, the rate of oxidation was fast for formulation 3, despite there being a lower amount of phosphine. DSC analysis of these polymers after oxidation reveals an increase in the Tg (Table 2).

TABLE 2
T_{g} values for all synthesized polymers

| | | |
|---|---|---|
| 1 | −61 | −39 |
| 2 | −52 | −37 |
| 3 | −64 | −54 |
| 4 | 56 | — |
| 5 | 106 | — |
| 6 | 101 | — |

Higher phosphorus content promotes a more intense shift in the Tg due to greater oxidation. The inventors believe that the formation of a P═O bond increases the polarity of the network thus reducing motion within the polymer. In contrast to formulations 1 to 3, formulations 4 to 6 possessed much higher glass transition temperatures, low swellability, and high gel content. The reason for these observations stem from the structure of the olefin used.

Despite both alkenes shown in FIG. 3B and FIG. 3C possessing similar molecular masses, the compound shown in FIG. 3C has a functionality of three in addition to a rigid cyclic core. Compound shown in FIG. 3B has a functionality of two and a flexible tetraethyleneglycol backbone, promoting lower crosslink densities and a more mobile network. These results are consistent with thiol-ene polymers and exemplify the similarities between sulfur and phosphorus systems. This suggests that research conducted on thiol-ene systems may directly apply to phosphane-ene polymers, accelerating the application of the present disclosure.

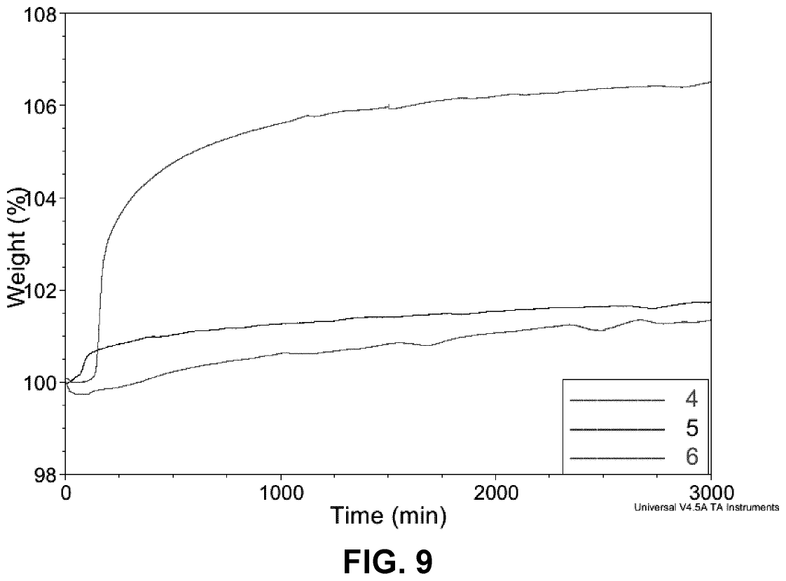

Formulations 4 to 6 were screened for their oxidative properties. They were analyzed in the TGA instrument by first heating to 120° C. for 15 minutes under a nitrogen atmosphere to remove any residual solvent. The sample was then cooled to 25° C. and left for 10 minutes. Dry air was then introduced and the sample was kept at 25° C. for 30 minutes before heating at a rate of 2° C./min until 120° C. for 3000 minutes. The oxidative stability of these formulations was noticeably greater than the softer networks (FIG. 9).

It was only when the firmer polymers were heated did any oxidation occur. Formulation 4 oxidized easier than the other two systems probably due to its lower Tg. This demonstrates a strong relationship between oxidative stability and polymer Tg. Such behaviour may be exploited in flame retardant materials or as an oxygen barrier where the oxidation mechanism is triggered by temperature. Such processes have yet to be discovered or exploited in phosphane-ene systems.

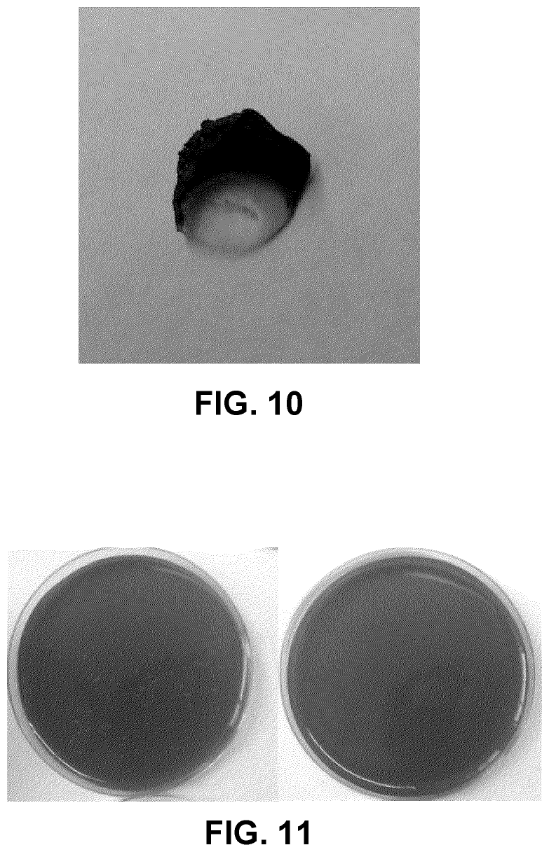

Upon removal of the sample from a flame, the inventors observed a self-extinguishing effect leaving behind a charred material (FIG. 10). These polymers may be cast on metal, plastic, glass, or wood substrates utilizing UV-curing methodologies currently used in industry.

### Antimicrobial Properties Through Contact Killing

Contact-killing surfaces are defined as materials that promote bacterial death through direct interaction of the surface with the bacteria. This is in contrast to other antimicrobial materials that kill by releasing small molecules to the environment. The most common polymers used for contact- killing to date are quaternary ammonium and phosphonium polyelectrolytes. It is believed that the positively charged polymer promotes bacterial lysis resulting in death. Phosphonium salts are generated by reacting tertiary phosphines with an electrophile (e.g. alkyl halides). The phosphane-ene networks of the present disclosure serve as an excellent precursor for polyelectrolyte fabrication as the final product after polymerization possesses a large amount of tertiary phosphines.

Formulation 5 was chosen for the preliminary antimicrobial studies. To generate a polyelectrolyte network, the polymer disk (˜70 mg) was immersed in a concentrated solution of ethyl iodide in acetonitrile (1.0 M) for 3 days at room temperature. The polymer was then dried in vacuo at 100° C. for 24 hours to remove all traces of alkyl halides, and then placed in a water-filled Soxhlet extractor for 12 hours. Upon immersion of the sample in to an aqueous sodium fluorescein solution, the polymer turned bright red indicating the presence of cationic group. A freshly prepared sample was then used for antimicrobial testing using a procedure described above.

The present inventors found that over 90% of the bacteria was killed over a 24 hour period (FIG. 11). These results represent a prospective new approach to generate antimicrobial surfaces using phosphonium units present in the main-chain of the polymer.

### Stability of Polymer Formulation

The wide-spread use of (meth)acrylates and styrenes in industry stems not only from the properties of the resulting materials, but also due to ease of handling and storage. Often these systems may be stored at temperatures up to 25° C. for months at a time, depending on inhibitor type and concentration. The inventors explored the stability of the phosphane-ene systems according to the present disclosure to determine whether autopolymerization was a significant issue.

Studies were carried out on formulation 2 without the addition of any initiator. It was found that this system was stable under a nitrogen atmosphere for days with and without the addition of butylated hydroxytoluene (BHT, 2 wt ). However, when exposed to an oxygen rich atmosphere, polymer was visibly seen in a matter of minutes for the unstablized solution. The formulation containing BHT however did not exhibit any polymerization for up to one hour. After five hours, the formulation was noticeably viscous and large amounts of phosphine oxides and some secondary phosphines were detected by ³¹P{¹H} NMR spectroscopy.

Phosphine oxidation is believed to occur via a radical mechanism with molecular oxygen. The presence of these radicals most likely initiates the polymerization. The formation of only a small number of radicals may facilitate thousands of bond-forming reactions. BHT is a well-known anti-oxidant and inhibitor for systems utilizing radical reactions and proved to be effective at stabilizing these systems for a short a time. The inventors believe that the key to preventing autopolymerization of phosphane-ene systems is by preventing phosphine oxidation. This is in stark contrast to thiol-ene systems whose instability stems from a plethora of factors, none of which include sulfur oxidation.

Previous work has shown that the oxidation of tributylphosphine in hexanes can be significantly inhibited by a small amount of diphenylamine. Upon addition (2 wt ) to the formulations of the present disclosure, the inventors observed a significant increase in stability relative to BHT, with the formation of ˜1% phosphine oxide and secondary phosphines after 5 hours. Given these results and the research currently conducted on thiol-ene stabilization, the present inventors believe that the use of more powerful and specialized inhibitors may extend the lifespan of phosphane-ene systems in an oxygen rich atmosphere. Further work includes determining whether these stabilized formulations may be photopolymerized in air as opposed to nitrogen with similar efficiency.

### Metal Scavenging Polymer and Solid-Supported Catalysis

The toxicity of a large number of heavy metals is a persistent problem in waste management and in the pharmaceutical industry. Metals such as palladium, ruthenium, platinum, and rhodium are routinely used in catalysis to promote chemical transformations that are desirable in drug manufacturing. There are significant limitations for their use as there must only be a trace amount of metal left over in the final product. Quite often the catalysis is performed early in the synthetic route as subsequent purification steps often lower the amount of metal, but this approach does not apply to every synthesis. Two methodologies however may be implemented to solve this problem. The first is through the use of a metal scavenging polymer that binds metals from the reaction mixture, or instead to support the catalyst on to a polymer as to not lose the active material to solution. The inventors were interested in both approaches using “phosphane-ene” polymer systems. The two metallic species which the inventors are interested in include palladium (PdCl₂ and Pd(PPh₃)₄) and ruthenium (Grubbs catalyst 1st generation). Formulation 2 was chosen as the polymer to perform the metal sequestration. Upon mixing either metal with the polymer in toluene, the inventors noticed a transfer of colour from solution to the polymer.

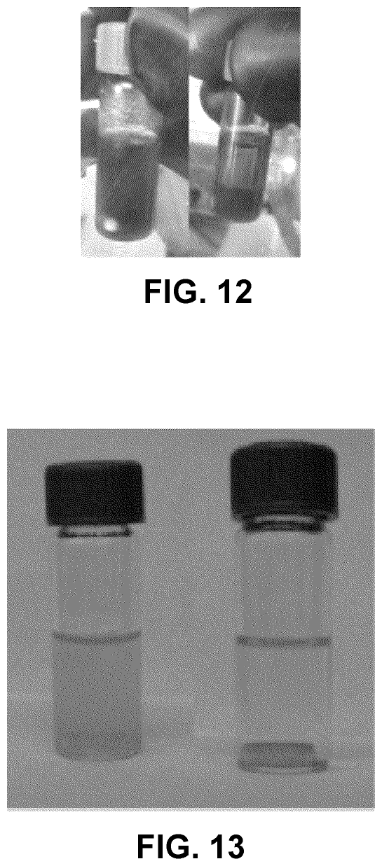

FIG. 12 shows Ru metal binding to the polymer. The image on the left was taken at T0 while the image on the right taken after 2 hours. The polymer became noticeably darker which could not be removed by solvent rinsing. The same experiment was conducted using Pd(PPh₃)_{4.} The solution became much clearer after stirring for two hours. The advantage of this approach relies on the ease of isolating the metallic components from solution. The insoluble polymer collects at the bottom of the vessel along (FIG. 13). The solution may then be filtered or decanted.

Metal content of these polymers was determined by ICP (Inductively Coupled Plasma) analysis. It was found that that there was approximately 14 and 31 mg of metal/gram of polymer for the Grubbs catalyst and Pd(PPh₃)₄ systems respectively. While other systems employ the use of aryl phosphines for this task, the present inventors believe that using alkyl phosphines may result in greater binding affinity and thus better scavenging behaviour.

The process of synthesis of phosphine polymer disclosed herein is very advantageous since synthesizing polymers using P—C bond forming reactions has typically been difficult due to the instability of the phosphorus starting materials. The synthesis methods disclosed herein for polymer fabrication relies on substantially increasing the stability of the phosphorus monomer without reducing reactivity. This is accomplished by tailoring the phosphine starting material using research in fundamental phosphorus chemistry while using commercially available inhibitors to promote greater formulation stability. The present inventors believe that this approach represents the first and only case where phosphine polymer formulations display significantly increased tolerance to atmospheric oxygen. This is a noteworthy achievement towards the goal of synthesizing phosphine polymers without stringent atmospheric requirements.

### SUMMARY

In summary, in an embodiment, the present disclosure provides a method for producing a phosphorus based polymer network, comprising:

mixing a polymerization initiator with a primary phosphine and an olefin to produce a mixture and exposing the mixture to an agent selected to activate the polymerization initiator to induce polymerization of the primary phosphine with the olefin wherein the reactivity of the primary phosphine results in the production of polymers containing P—C bonds.

In an embodiment, the polymerization initiator is any one of a photoinitiator, a thermal initiator or an e-beam initiator.

The agent selected to activate the polymerization initiator may be any one or combination of electron beam, heat and light.

In an embodiment, the polymerization initiator is any one of bisacyl phosphineoxide derivatives (BAPO), VAZO type initiators, phenylacetylphenone derivatives, substituted phenylacetylphenone derivatives, acylgermanes and acylstannanes.

In an embodiment, the VAZO type initiators are substituted azonitrile compounds.

In an embodiment, the primary phosphine is a compound having the general formula of R—PH2 wherein R may be any one of an optionally substituted alkyl group, optionally substituted heteroalkyl group, optionally substituted cyclic alkyl groups, optionally substituted heterocyclic alkyl group, optionally substituted aryl groups, optionally substituted heteroaryl groups, or optionally substituted aralkyl group. In an embodiment, the alkyl group comprises 2 to 25 carbon atoms.

In an embodiment, the cyclic alkyl is any one of cyclohexyl or substituted cyclohexyl, adamantly or substituted adamantly and pineneyl or substituted binenyl group, and the aryl group is any one of Naphthyl or substituted naphtyl, terphenyl or substituted terphenyl, binaphthyl or substituted binaphthyl.

In an embodiment, the olefin is a multifunctional alkene having two or more carbon-carbon double bonds (C═C) linked by an aliphatic chain, and the one or more carbon atoms in the aliphatic chain may be optionally substituted by one or more heteroatoms.

In an embodiment, the olefin is a multifunctional alkene having two or more unsaturated aliphatic chains linked by a cyclic group. The cyclic group may be a heterocyclic aliphatic group or an aromatic group.

In an embodiment, the cyclic group and carbon-carbon double bonds (C═C) in the unsaturated aliphatic chains are apart from each other by not more than three atoms.

In an embodiment, the each end of the olefin are terminated by a carbon-carbon double bond (C═C).

In an embodiment, the method further comprises adding an inhibitor of phosphine oxidation.

In an embodiment, the molar ratios of primary phosphine:alkene range from about 0.05:0.95 to about 0.95:0.05.

In an embodiment, the polymerization initiator is added in the amount of about 0.01 to about 10 mol % of either primary phosphine or olefin.

In an embodiment, the present disclosure provides a phosphorus based polymer network produced by the method described above. This polymer network is characterized by tunable oxidative and mechanical properties.

In an embodiment, this polymer network is used as a flame retardant.

In an embodiment, this polymer network is used as an antibacterial agent.

In an embodiment, this polymer network is used as a metal scavenger.

### Utility

Harnessing the chemistry of phosphorus in polymeric systems allows these new materials to be used as flame-retardants with tunable physical and oxidative properties, and as metal scavengers to remove heavy metals from organic solvent. This breadth of applications for the new materials disclosed herein can be achieved using a general approach that is compatible with current industrial processes.

The foregoing description of the preferred embodiments of the present disclosure has been presented to illustrate the principles of the disclosure and not to be limited to the particular embodiment illustrated. It is intended that the scope of the disclosure be defined by all of the embodiments encompassed within the following claims and their equivalents.

1. A method for producing a phosphorus based polymer network, comprising:
mixing a polymerization initiator with a primary phosphine and an olefin to produce a mixture and exposing the mixture to an agent selected to activate the polymerization initiator to induce polymerization of the primary phosphine with the olefin wherein the reactivity of the primary phosphine results in the production of polymers containing P—C bonds.

2. The method according to claim 1 wherein said polymerization initiator is a photoinitiator, a thermal initiator or an e-beam initiator.

3. The method according to claim 1 wherein the agent selected to activate the polymerization initiator is any one or combination of electron beam, heat and light.

4. The method according to claim 1 wherein the polymerization initiator is any one of bisacyl phosphineoxide derivatives (BAPO), VAZO type initiators, phenylacetylphenone derivatives, substituted phenylacetylphenone derivatives, acylgermanes and acylstannanes.

5. The method according to claim 4 wherein the VAZO type initiators are substituted azonitrile compounds.

6. The method according to claim 1 wherein the primary phosphine is a compound having the general formula of R-PH₂ wherein R is any one of an optionally substituted alkyl group, optionally substituted heteroalkyl group, optionally substituted cyclic alkyl groups, optionally substituted heterocyclic alkyl group, optionally substituted aryl groups, optionally substituted heteroaryl groups, or optionally substituted aralkyl group.

7. The method according to claim 6, wherein the alkyl group comprises 2 to 25 carbon atoms.

8. The method according to claim 6 wherein the cyclic alkyl is any one of cyclohexyl or substituted cyclohexyl, adamantly or substituted adamantly and pineneyl or substituted binenyl group, and the aryl group is any one of Naphthyl or substituted naphtyl, terphenyl or substituted terphenyl, binaphthyl or substituted binaphthyl.

9. The method according to claim 1 and wherein the olefin is a multifunctional alkene having two or more carbon-carbon double bonds (C═C) linked by an aliphatic chain.

10. The method according to claim 9 and wherein one or more carbon atom in the aliphatic chain is optionally substituted by one or more heteroatom.

11. The method according to claim 1 wherein the olefin is a multifunctional alkene having two or more unsaturated aliphatic chains linked by a cyclic group.

12. The method according to claim 11 wherein the cyclic group is a heterocyclic aliphatic group or an aromatic group.

13. The method according to claim 11 wherein the cyclic group and carbon-carbon double bonds (C═C) in the unsaturated aliphatic chains are apart from each other by not more than three atoms.

14. The method according to claim 1 wherein each end of the olefin is terminated by a carbon-carbon double bond (C═C).

15. The method according to claim 1 further comprising adding an inhibitor of phosphine oxidation.

16. The method according to claim 1, wherein molar ratios of primary phosphine: alkene is in a range from about 0.05: 0.95 to about 0.95: 0.05.

17. The method according to claim 1, wherein the polymerization initiator is added in the amount of 0.01-10 mol % of either primary phosphine or olefin.

18. A phosphorus based polymer network produced by the method of claim 1.

19. The polymer network according to claim 18, characterized by tunable oxidative and mechanical properties.

20. The polymer network according to claim 18, wherein said network is in a flame retardant.

21. The polymer network according to claim 18, wherein said network is in an antibacterial agent.

22. The polymer network according to claim 18, wherein said network is in a metal scavenger.
